(19) United States
(12) Patent Application Publication
(10) Pub. No.: US 2016/0113240 A1
(43) Pub. Date: Apr. 28, 2016

(54) PROTECTIVE COVERING PROVIDING PRESSURE RELIEF AREAS

(71) Applicant: EquiFit, Inc., Dedham, MA (US)

(72) Inventors: Alexandra CHERUBINI, Boston, MA (US); Richard CLEMENT, Sudbury, MA (US)

(73) Assignee: EquiFit, Inc., Dedham, MA (US)

(21) Appl. No.: 14/921,610

(22) Filed: Oct. 23, 2015

Related U.S. Application Data
(60) Provisional application No. 62/067,563, filed on Oct. 23, 2014.

(51) Int. Cl. A01K 13/00; A61D 9/00

(52) U.S. Cl. CPC A01K 13/007; A01K 13/006; A61D 9/00

(57) ABSTRACT

A protective covering for an animal (e.g., a horse, mule, human, dog or other skeletal mammal). In some embodiments, the protective covering may have one or more relief zone areas comprised of separate resilient sections that may be arranged in a grid or other pattern that are removably secured on their lower surfaces to an underlying flexible surface. The sections may be capable of being individually removed to provide localized pressure relief to selected areas, and the resilient sections may be directly adjacent to one another to form a grid, whereby one or a plurality of the adjacent sections may be removed at any desired area of the covering to provide relief corresponding to the afflicted zone of the animal's (e.g., horse's) body part (e.g., leg).

### CROSS-REFERENCE TO RELATED APPLICATION

The present application claims the benefit of priority to U.S. Provisional Application Ser. No. 62/067,563, filed on Oct. 23, 2014, which is incorporated herein by reference in its entirety.

### TECHNICAL FIELD

This invention relates to protective coverings for animals (e.g., horses, mules, other livestock, humans, dogs, skeletal mammals, etc.), providing pressure relief areas.

### BACKGROUND

Animals, such as, for example, horses, mules and other livestock, are susceptible to a variety of injuries. As examples, a horse may develop a swelling in various areas of its leg due to equine sports activities or playing in the field; a horse may be kicked by another horse; a horse may strike a portion of its leg during equine sports, in its stall, in a trailer, or in a field; and a horse may simply develop an irritation in an area of its leg caused by heat and/or bacteria. For all of the above reasons, it is well known to provide protective wrappings or boots as a covering for a portion of a horse's leg. Such protective wrappings and boots are used for a variety of purposes, ranging from providing support for an injured leg to protecting the leg from further injury or damage.

Often times a problem encountered with the use of protective wrappings and boots is that it is necessary to provide uneven support across the surface of the leg. For example, it may be necessary to provide support on the majority of the leg but to keep pressure off of the exact area of a cut or injury. Another example is that it may be necessary to provide support on the majority of the leg to prevent further injury, but to keep pressure off of an area of irritation.

The following patents relate to known pressure-relieving coverings—U.S. Pat. No. 2,909,854 (Edelstein), U.S. Pat. No. 5,329,705 (Grim et al.), U.S. Pat. No. 5,761,834 (Grim, et al.) and U.S. Pat. No. 5,768,803 (Levy et al.). However, there is a need for improved protective coverings.

### SUMMARY

Embodiments of the present invention may provide a comfortable cushioned protective covering for an animal (e.g., horse, mule, other livestock, humans, dogs, skeletal mammals, etc.) which may be conveniently modified to provide pressure relief to specific areas.

Aspects of the present invention may be directed to a protective covering for an animal that satisfies the aforementioned needs. In some embodiments, the protective covering may have one or more relief zone areas comprised of separate resilient sections that may be arranged in a grid or other pattern that are removably secured on their lower surfaces to an underlying flexible surface. The sections may be capable of being individually removed to provide localized pressure relief to selected areas, and the resilient sections may be directly adjacent to one another to form a grid, whereby one or a plurality of the adjacent sections may be removed at any desired area of the covering to provide relief corresponding to the afflicted zone of the animal's (e.g., horse's) body part (e.g., leg).

Additional features of some non-limiting embodiments of the invention may include one or more of the following:

1. In some non-limiting embodiments, one or more resilient sections may be removed from an outer surface of a flexible inner liner that is opposite an inner surface of the flexible inner liner that is configured to be continuous against the horse. When the one or more sections are removed, the inner surface of the flexible liner, which is configured to be against the horse, will remain continuous, and removal of the one or more resilient sections creates air-filled gaps (e.g., between the flexible liner inner surface and any outer liners of the protective covering).
2. In some non-limiting embodiments, the resilient sections may be removed from an inner surface of the flexible liner that is configured to be against the horse. When one or more resilient sections are removed from the inner surface of the flexible inner liner, which is against the horse, will remain continuous except for the areas where the resilient sections are removed. In these embodiments, air-filled gaps are created between the horse and the protective covering.
3. In some non-limiting embodiments, the removed sections may be reapplied and other resilient sections may be removed, such that the same protective covering may be reused to provide different areas of pressure relief to different areas.
4. The removable resilient sections may be located/grouped in any of a variety of locations (relief zone areas). For example, some protective coverings may have only one relatively small relief zone area (such as the fetlock region of a splint boot), whereas other protective coverings may have one or more relief zone areas that comprise almost the entire covering (such as entire splint boot).
5. The removable resilient sections may be held in place by a variety of possible means including but not limited to pressure sensitive adhesive and hook and loop (velcro), such that the sections can be removed and replaced.
6. The removable resilient sections may be arranged within the relief zone area(s) in a variety of possible configurations, including but not limited to a grid.
7. The invention may be manufactured and sold together with an outer protective covering, or separately as just a liner.
8. The invention may be made to accommodate a variety of different body parts, in a variety of sizes and the relief zone areas can be for a variety of different locations. Some non-limiting examples include fetlock boots/liners, split boots/liners, hock boots/liners, halter coverings, saddle pads, and girth covers.

### BRIEF DESCRIPTION OF THE DRAWINGS

The accompanying drawings, which are incorporated herein and form part of the specification, illustrate one embodiment of the present disclosure, and together with the description, further serve to enable a person skilled in the pertinent art to make and use the invention described herein.

FIGS. 1A and 1B are front views of two protective coverings each embodying aspects of the present invention.

FIG. 2 is a rear view of a protective covering embodying aspects of the present invention, which depicts a side of the protective covering that may face an animal's leg.

FIGS. 3A and 3B-3D are front and cross-sectional views, respectively, of a protective covering embodying some aspects of the present invention.

FIGS. 4A and 4B-4D are front and cross-sectional views, respectively, of a protective covering embodying some aspects of the present invention.

FIGS. 5A and 5B-5D are front and cross-sectional views, respectively, of a protective covering embodying some aspects of the present invention.

FIG. 6 is a blown-up cross-sectional view of a protective covering embodying aspects of the present invention.

FIG. 7 is a blown-up cross-sectional view of a protective covering embodying aspects of the present invention.

### DETAILED DESCRIPTION

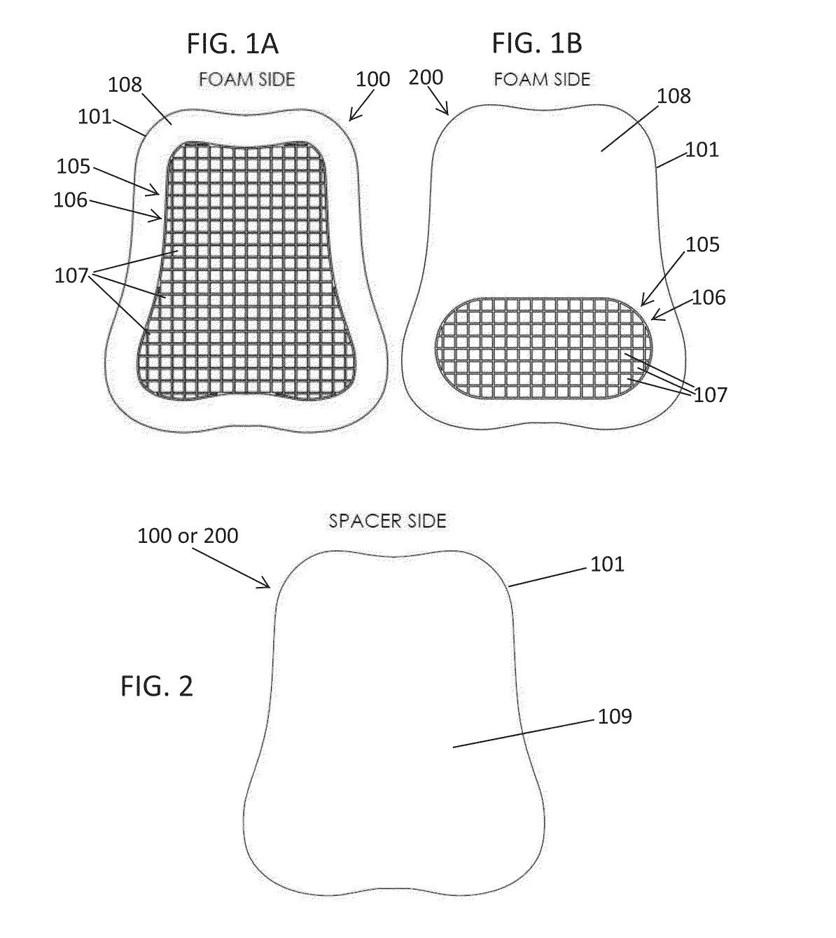

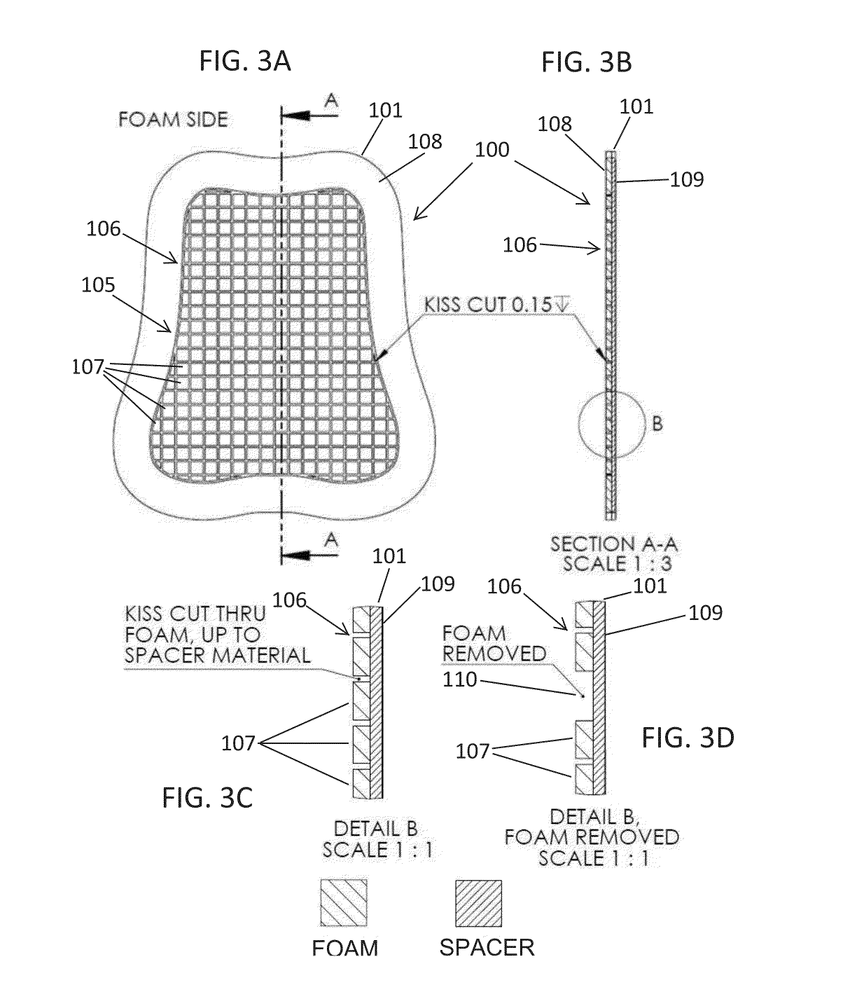

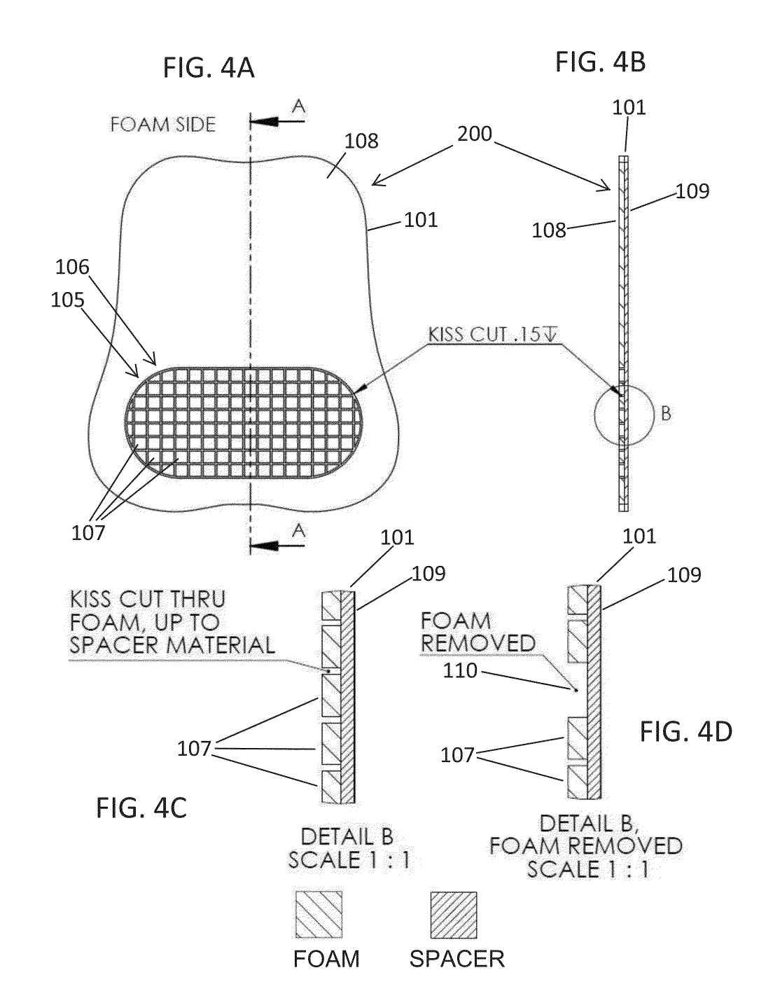

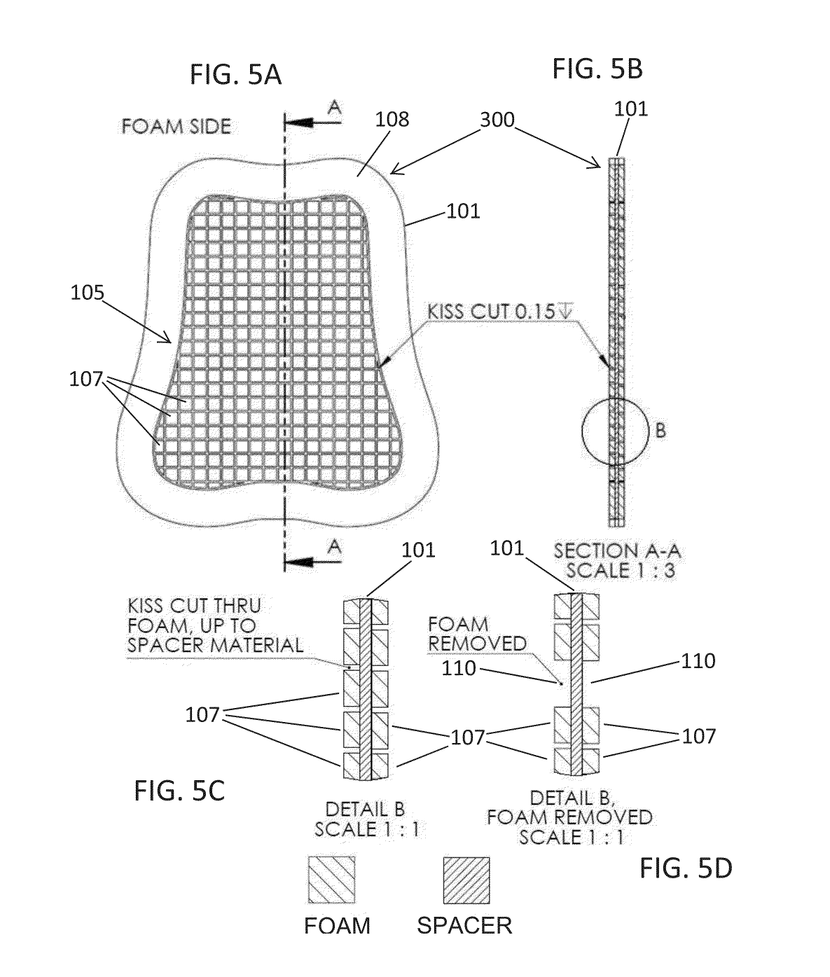

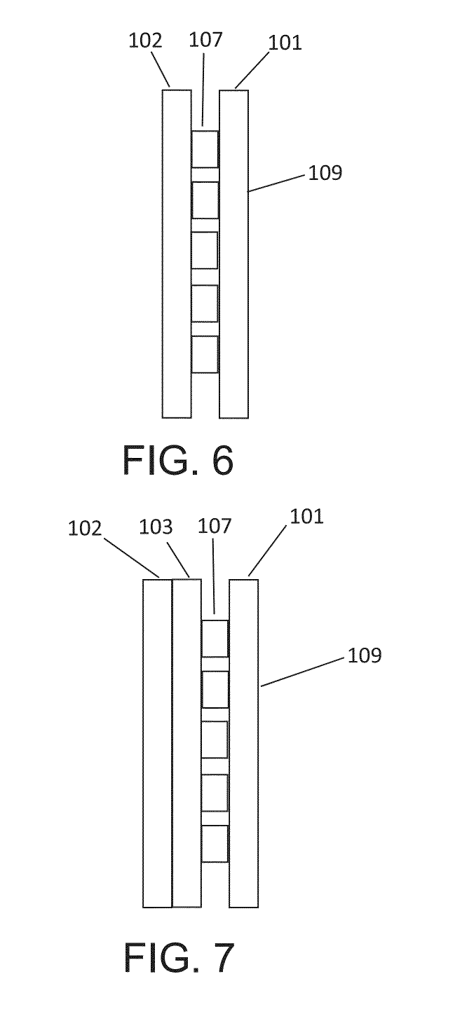

FIGS. 1A-5D provide multiple views of protective coverings 100, 200, and 300 for a body part (e.g., a leg) of an animal (e.g., horse, mule, human, dog, or other skeletal mammal) embodying aspects of the present invention. FIG. 1A illustrates a front view of a protective covering 100 according to some non-limiting embodiments of the invention, and FIG. 1B illustrates a front view of a protective covering 200 according to some non-limiting embodiments of the invention. FIG. 2 illustrates a rear view of the protective covering 100 or 200 according to some non-limiting embodiments of the invention. FIGS. 3A, 3B, and 3C-3D illustrate front, cross-sectional, and blown-up cross-sectional views, respectively, of the protective covering 100 according to some non-limiting embodiments of the invention. FIGS. 4A, 4B, and 4C-4D illustrate front, cross-sectional, and blown-up cross-sectional views, respectively, of the protective covering 200 according to some non-limiting embodiments of the invention. FIGS. 5A, 5B, and 5C-5D illustrate front, cross-sectional, and blown-up cross-sectional views, respectively, of the protective covering 300 according to some non-limiting embodiments of the invention. FIGS. 6 and 7 are blown-up cross-sectional views of a protective covering 100 according to some non-limiting embodiments of the invention.

As illustrated in FIGS. 1A-3D, in some non-limiting embodiments, one or more of protective coverings 100 and 200 may include an inner liner 101. FIGS. 1A and 1B show embodiments of the protective coverings 100 and 200, respectively, depicted from the outer side of the protective covering 100 or 200 that, in use, may face away from the animal's leg and toward a protective boot. In the depicted embodiment, the fetlock region shows a relief zone area 105. In the illustrated embodiments, the protective covering 100 or 200 comprises a grid 106 of removable resilient sections 107. In some embodiments, the removable resilient sections 107 may be removably attached to a continuous, flexible outer surface 108 of the inner liner 101.

FIG. 2 shows a protective covering 100 or 200 with the inner liner 101 depicted from the rear side that, in use, faces toward the horse's leg. As shown in FIG. 2, in some non-limiting embodiments, the inner liner 101 may have a continuous inner surface 109 configured to be in contact with the horse's leg.

As illustrated in FIGS. 3A-3D, in some embodiments, while the protective covering has a continuous inner surface 109 configured to be in contact with the horse's leg, the resilient sections 107 may be configured to be removable from the outer surface 108 in the relief zone area 105. FIG. 3D is a blown-up cross-section of the protective covering 100 after one or more resilient sections 107 were removed from the relief zone area 105 to create an air-filled gap 110 (i.e., the space previously occupied by the removed resilient section(s) 107. The air-filled gap 110 created by removal of one or more of the resilient sections 107 may provide pressure relief for a corresponding area of the horse's leg. The inner surface 109 of the inner liner 101 may remain a continuous surface even after one or more resilient sections 107 are removed from the outer surface 108 of the inner liner 101.

As illustrated in FIGS. 4A-4D, in some embodiments, the protective covering 200 may include removable resilient sections 107 that may be removably attached to the outer surface of the inner liner 101. In some embodiments, the continuous inner surface 109 may be configured to contact a horse's leg even in areas where a one or more of resilient sections 107 were removed in a relief zone area 105. In those areas, there is an air-filled gap 110 that provides pressure relief for that area of the horse's leg.

FIGS. 5A-5D illustrate a protective covering 300 according to some embodiments. The protective covering 300 may include one or more resilient sections 107 removably attached to the outer surface 108 of the inner liner 101 and one or more resilient sections 107 removably attached to the inner surface 109 of the inner liner 101. In some embodiments, the protective covering 300 may include a grid of resilient sections 107 on the outer surface 108 of the inner liner 101 and/or a grid of resilient sections 107 on the inner surface 109 of the inner liner 101. In some embodiments, a surface created by resilient sections 107 on the inner surface 109 of the inner liner 101 may create a surface that, in use, is substantially continuous against a horse's leg except for the areas where one or more resilient sections 107 were removed. In these embodiments, the protective coating 300 may be configured such that removal of one or more of the resilient sections 107 on the inner surface 109 of the inner liner 101 creates air-filled gaps 110 between the horse and the protective covering, which may provide pressure relief for one or more areas of a horse's leg.

As illustrated in FIG. 6, in some non-limiting embodiments, one or more of protective coverings may additionally include an outer layer 102. As illustrated in FIG. 7, in some non-limiting embodiments, the one or more of protective coverings may include an outer layer 102 and one layer 103 between the inner liner 101 and the outer layer 102. For example, in one non-limiting embodiment, the layer 103 may be foam (e.g., a 1/8 inch thick layer of foam), and the outer layer 102 may be a fabric or textile laminated on the outer surface of the layer 102. However, neither the outer layer 102 nor the layer 103 are required, and, in some embodiments, the protective covering may not include an outer layer 102 and may not include a layer 103.

In some non-limiting embodiments, one or more of the layers, 101, 102, and 103, may be secured to one another via a variety of means, including but not limited to adhesives, including flame lamination, and/or hook and loop fasteners (velcro).

In some non-limiting embodiments, the air filled gaps 110 may have a variable size and/or shape, depending on how many and which removable resilient sections 107 in the relief zone area 105 were removed, and whether the removed resilient sections 107 were adjacent to one another or not. Also, in some non-limiting embodiments, the air filled gaps 110 may be located in different or multiple layers.

In some non-limiting embodiments, the flexible inner liner 101 and any additional layers between the flexible liner and the outer layer 103 may be made of a single thickness fabric or multidimensional material with or without stretch properties, such as Lycra or spandex. In some non-limiting embodiments, the fabric or material may be perforated or breathable, and may be treated with an agent to provide antimicrobial antifungal attributes. In some non-limiting embodiments, the plurality of resilient sections could be removably secured to the continuous surface via adhesive, including flame lamination, or via hook and loop fasteners (e.g., velcro).

In some non-limiting embodiments, the plurality of resilient sections 107 could be correspondingly labeled to match labels on the underlying flexible surface such that a user could easily replace removed sections to their original locations.

In operation, the protective covering 100, 200, or 300 may be put on a horse's leg after one or more of the removable resilient sections 107 in the relief zone area 105 may be removed to create an air-filled space or gap 110. In some non-limiting embodiments, an affected/injured area of the horse's leg may be first marked with a chalk or other marking agent, and the protective covering 300 may be put on the horse's leg and removed, such that the chalk or other marking agent is transferred to the removable resilient sections 103 that contact the affected area of the horse's leg. In this non-limiting embodiment, one will be able to determine what removable resilient sections 107 from the relief zone area 105 should be removed to provide the needed pressure relief for the horse's leg. Once the appropriate resilient sections 107 are removed, the protective covering 300 may be put on the horse's leg.

Embodiments of the present invention have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention. For example, although some embodiments of the present invention are directed to a protective covering for a horse's leg, this is not required, and, in some alternative embodiments, the protective covering may be for a different body part or a different animal (e.g., a mule, human, or dog). For instance, in one non-limiting embodiment, the protective covering may be for a horse's back, such as a saddle pad. In another non-limiting embodiment, the protective coating may be incorporated in any padding with which livestock may be dressed.

What is claimed is:

1. A protective covering comprising:
an inner liner comprising an inner surface, an outer surface, and one or more relief zone areas on the outer surface, wherein the inner surface of the inner liner is configured to contact a body part; and
a plurality of resilient sections that are removably secured to the outer surface of the inner liner in the one or more relief zone areas.

2. The protective covering of claim 1, wherein the plurality of resilient sections are configured such that removal of one or more of the plurality of resilient sections creates one or more air-filled relief spaces.

3. The protective covering of claim 1, wherein said resilient sections are of different sizes.

4. The protective covering of claim 1, wherein said resilient sections are disposed adjacent to one another.

5. The protective covering of claim 1, wherein said resilient sections are arranged in a grid pattern.

6. The protective covering of claim 1, further comprising an outer layer.

7. The protective covering of claim 6, further comprising one or more layers between the flexible liner and the outer layer.

8. A protective covering comprising:
an inner liner comprising an inner surface, an outer surface, and one or more relief zone areas on the outer surface;
a first plurality of resilient sections that are removably secured to the outer surface of the inner liner in the one or more relief zone areas;
a second plurality of resilient sections that are removably secured to the inner surface of the inner liner.

9. The protective covering of claim 8, wherein the second plurality of resilient sections is configured to contact a body part.
